(19) United States
(12) Patent Application Publication
(10) Pub. No.: US 2017/0278102 A1
(43) Pub. Date: Sep. 28, 2017

(54) IMMUNISATION METHOD FOR USER BEHAVIOUR MODEL DETECTION IN ELECTRONIC TRANSACTION PROCESS

(71) Applicant: TONGJI UNIVERSITY, SHANGHAI (CN)

(72) Inventors: CHANGJUN JIANG, SHANGHAI (CN); CHUNGANG YAN, SHANGHAI (CN); HONGZHONG CHEN, SHANGHAI (CN); ZHIJUN DING, SHANGHAI (CN); SHAOPING JIANG, SHANGHAI (CN)

(73) Assignee: TONGJI UNIVERSITY, SHANGHAI (CN)

(21) Appl. No.: 15/504,826

(22) PCT Filed: Sep. 14, 2015
(86) PCT No.: PCT/CN2015/089511

§ 371 Date: Feb. 17, 2017

(30) Foreign Application Priority Data
Sep. 25, 2014 (CN) 2014104952954

(51) Int. Cl. G06Q 20/38; G06Q 20/40

(52) U.S. Cl. CPC G06Q 20/382; G06Q 20/401

(57) ABSTRACT

An immunization detection method for a user behavior mode in an electronic transaction process, comprising a data preprocessing step of mainly processing a user operation process into a sequence format and cleaning related repeated data; a training step of mainly calculating an age value of each sequence according to a time order and according to an age evolution process, deleting aged logs according to the age values and extracting a normal sequence library; a detection step of mainly detecting whether a newly generated transaction sequence is mutated or not; and an updating step of updating age values of selves and non-selves in time according to a detection result and updating a related library set. The method is oriented to abnormal situations in the electronic transaction process, which may be misoperation by users.

### BACKGROUND OF THE PRESENT INVENTION

Field of Invention

The present invention relates to the field of e-commerce security.

Description of Related Arts

In recent years, e-commerce is quickly developed in China. In the past year, the performance of electronic transaction reached a new height. However, potential hazards exist behind high-speed development. Since the technology is not mature and the start is late, the electronic transaction credibility crisis situation in China is severer than that in other countries, and malicious behaviors such as fraudulent, illegal use of accounts and phishing emerge in endlessly. These malicious behaviors and misoperation of users are not in compliance with user behavior habits and are abnormal situations in electronic transaction processes.

During actual application, the traditional account password system has already been unable to guarantee electronic transactions to be credible, and the existing invasion detection means cannot adapt to new fraudulent means. Therefore, at present e-commerce and third-party payment platforms generally adopt a manual detection method and limit abnormal behaviors by adding rules. Although the false detection rate of this method is low, the adaptability is poor and a great amount of manpower and material resources are spent.

### SUMMARY OF THE PRESENT INVENTION

An immunization method for a user behavior mode detection in an electronic transaction process is a process of extracting a normal sequence library which can best reflect recent behavior habits of a user according to historical transaction operation sequences of the user and according to an age evolution process; and when a new transaction sequence is generated, detecting whether the newly generated sequence is abnormal or not according to an abnormal sequence library and the normal sequence library; and updating the corresponding library in time according to a detection result.

The technical solution of the present invention is as follow:

An immunization detection method for a user behavior mode in an electronic transaction process comprising the following steps:

(1) a data preprocessing step

mainly processing a user operation process into a sequence format and cleaning related repeated data;

(2) a training step

mainly calculating an age value of each sequence according to a time order and according to an age evolution process, deleting aged logs according to the age values and extracting a normal sequence library (i.e., antibody). Specifically: establishing a normal sequence library (i.e., an antibody set Ab) and an abnormal sequence library (i.e., a non-selves library). Firstly performing affinity calculation to newly generated sequences and historical sequences according to an age evolution process, keeping an age unchanged if affinity is greater than a certain threshold β, or else increasing the age value by a sequence distance therebetween. After calculating age values of historical transaction operation sequences of a user, extracting a set of sequences with age values smaller than the threshold β according to magnitudes of ages and using the set of sequences as a normal transaction sequence library. Wherein sources of the non-selves transaction sequence library mainly comprise two aspects, one aspect is known illegal transaction sequences including some sequences with higher affinity with normal user behaviors; the other aspect is new abnormal sequences detected in the operation process such that a guarantee can be provided for that similar abnormal sequences can be detected in time at a next time to achieve an immunization effect. When the newly generated abnormal transaction sequences are added into the non-selves library, the age values of non-selves in the non-selves library are updated according to the age value evolution process, active non-selves therein are reserved and self-stabilized updating of the non-selves library is realized;

(3) a behavior mode detection step

detecting whether a newly generated transaction sequence is mutated or not, wherein the detection is “mutation” detection performed aiming at the newly generated transaction sequence Ag in two steps:

step one: comparing the newly generated transaction sequence Ag with the non-selves library, if matching is successful, alarming for behavior abnormality and taking relevant examination and user notification measures, or else, entering step two;

step two: comparing the newly generated transaction sequence Ag with normal transaction sequences (i.e., the antibody set Ab), if affinity with all antibodies is very low such that possible “mutation” of the sequence is indicated, alarming for abnormality and taking corresponding measures, or else, considering a detected behavior as a normal behavior; and

(4) an updating step

in order to improve detection accuracy, updating a normal mode library and an abnormal mode library in real time such that an immunization function to similar abnormal situations at a next time is owned on the basis that accurate detection can be performed.

According to a detection result, if the result is a normal behavior mode, performing age updating to the normal mode library (i.e., the antibody set Ab) according to the age evolution process and deleting “aged” logs therein to guarantee that the antibody set Ab can reflect recent behavior habits of the user; if the result is an abnormal behavior mode, comparing the abnormal behavior mode with modes in the abnormal library; and if the abnormal behavior mode is a new mode, adding the abnormal behavior mode into the abnormal mode library, updating the age values of non-selves sequences in the non-selves library and cleaning “aged” non-selves.

Mechanisms of the present invention are as follows:

in order to extract the recent behavior habits of the user, the aged sequences in the user transaction logs need to be cleaned, and this is fundamentally similar to an immunization self-stabilized mechanism that organisms clean aged cells to keep a body balance; and that detecting whether the newly generated transaction sequence of the user is normal or not, and cleaning the abnormal sequences in time have a certain commonality with an immunization monitoring mechanism that abnormal cells in organisms are eliminated in time. Accordingly, user behavior mode abnormality detection and a biological immunization system have a great number of similarities and abnormal situations can be detected by adopting the immunization method.

In order to improve user behavior credibility, the present invention provides the immunization method for the user behavior mode detection in the electronic transaction process, the logs which can reflect the user behavior habits in the electronic transaction process correspond to biological antibodies, antibody updating is realized by cleaning aged logs therein according to a biological immunization self-stabilized mechanism, thus the processed logs can reflect the recent behavior habits of the user, whether the newly generated transaction sequence is abnormal or not is detected according to the immunization monitoring mechanism, and the purpose of detecting whether the user behavior mode in the electronic transaction process is normal or not is achieved. According to the detection result, the related library is updated in time to guarantee that the similar situations can be detected in time at the next time and achieve the immunization effect.

The situations to which the present invention is oriented are abnormal situations in the electronic transaction process, which may be misoperation by users and may also be illegal operation caused by false account use or other situations which are not in compliance with user behavior habits. The present invention provides an immunization method for detecting abnormal user behaviors in an electronic transaction process for e-commerce and third-party payment platforms, and has the features of controllability and preventability, self-adaptability, self-learning, etc.

Innovations of the present invention are as follows:

1) the normal situations and abnormal situations of the user in the electronic transaction process are comprehensively considered to recognize new transactions as “selves” or “non-selves”;

2) since the age evolution process is introduced and the immunization self-stabilized function is realized by taking the age as a basis of aging, the change of user behavior habits can be known in time; and

3) the age values and the corresponding libraries are updated in time according to the detection result to guarantee that the similar abnormal modes which are met at the next time can be found in time and to achieve the immunization effect.

### BRIEF DESCRIPTION OF THE DRAWINGS

FIG. 1 is an integral architecture diagram of an immunization detection method for a user behavior mode in an electronic transaction process.

FIG. 2 is a data preprocessing process.

FIG. 3 is an age value evolution process of transaction sequences.

FIG. 4 is a user behavior mode detection process.

FIG. 5 is an overall flowchart of an immunization method.

FIG. 6 is comparison of experiment results of an immunization method and a sliding window method.

### DETAILED DESCRIPTION OF THE PREFERRED EMBODIMENTS

### EXAMPLES

FIG. 1 illustrates an integral architecture diagram of an immunization detection method for a user behavior mode in an electronic transaction process. The immunization detection method for the user behavior mode in the electronic transaction process mainly and sequentially consists of steps performed by a data preprocessing module, a training module, a detection module and an updating module. The data preprocessing module is mainly used for processing a user operation process into a sequence format and cleaning related repeated data; the training module is mainly used for calculating an age value of each sequence according to a time order and according to an age evolution process, deleting aged logs according to the age values and extracting a normal sequence library (i.e., antibody); the detection module is mainly used for detecting whether a newly generated transaction sequence is mutated or not; and the updating module is used for updating age values of selves and non-selves according to a detection result and updating the relevant library.

The immunization detection method for the user behavior mode in the electronic transaction process takes normal historical transaction records of the user as starting points, performs processing to obtain a normal transaction sequence library which can reflect recent behavior habits of the user, and generates an abnormal transaction sequence library through an immunization reverse selection algorithm. After a new transaction sequence is generated, two-step detection is needed, firstly a comparison with abnormal sequences is made, alarming is performed if that the new transaction sequence is abnormal is determined and further detection is performed; and contrarily, a comparison with the normal sequence library is made, updating operation is performed if that the new transaction sequence is normal is determined, or else, alarming is performed and further detection is performed.

A detailed introduction will be made below.

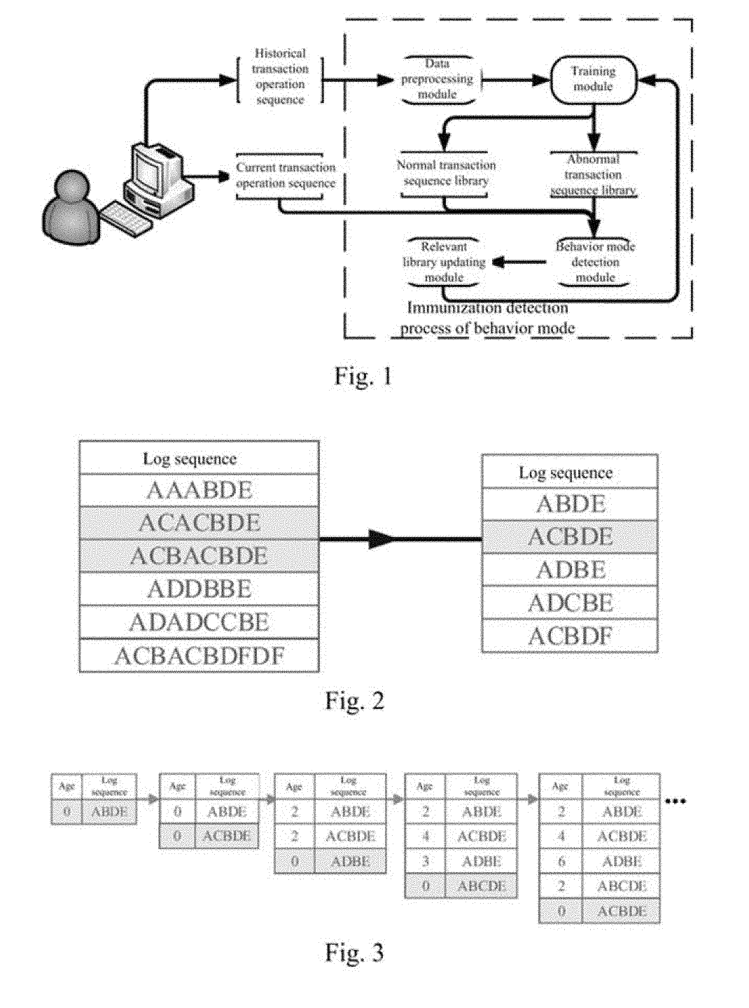

The data preprocessing module is mainly used for extracting transaction sequences illustrated in FIG. 2 according to an order of clicking controls in a user transaction process, and then performing a combination operation illustrated in FIG. 2 to the sequences to combine repeated items therein to obtain corresponding data formats.

For example, we extract the following relevant user operations according to a log of a buyer: A=search, B=order, C=shopping cart, D=examine, E=payment, F=cancel and G-return. The operations describe approximate operations of the buyer during shopping, wherein A represents a commodity search operation and is a start of a transaction, B and C respectively represent direct ordering or ordering after putting into a shopping cart, D represents balance inquiry which can be performed after B (or C) or performed at the same time, then F and E are choices, F represents order canceling, E represents response to payment, and G represents return and is an uncertain factor.

The training module is mainly used for establishing a normal sequence library (i.e., an antibody set Ab) and an abnormal sequence library (i.e., a non-selves library); firstly performing affinity calculation to newly generated sequences and historical sequences according to an age evolution process illustrated in FIG. 3, keeping an age unchanged if affinity is greater than a certain threshold β, or else increasing the age value by a sequence distance therebetween; and after calculating age values of historical transaction operation sequences of a user, extracting a set of sequences with age values smaller than the threshold β according to magnitudes of ages and using the set of sequences as a normal transaction sequence library.

Sources of the non-selves transaction sequence library mainly comprise two aspects, one aspect is known illegal transaction sequences including some sequences with higher affinity with normal user behaviors; the other aspect is new abnormal sequences detected in the operation process such that a guarantee can be provided for that similar abnormal sequences can be detected in time at a next time to achieve an immunization effect. When the newly generated abnormal transaction sequences are added into the non-selves library, the age values of non-selves in the non-selves library are updated according to the age value evolution process, active non-selves therein are reserved and self-stabilized updating of the non-selves library is realized.

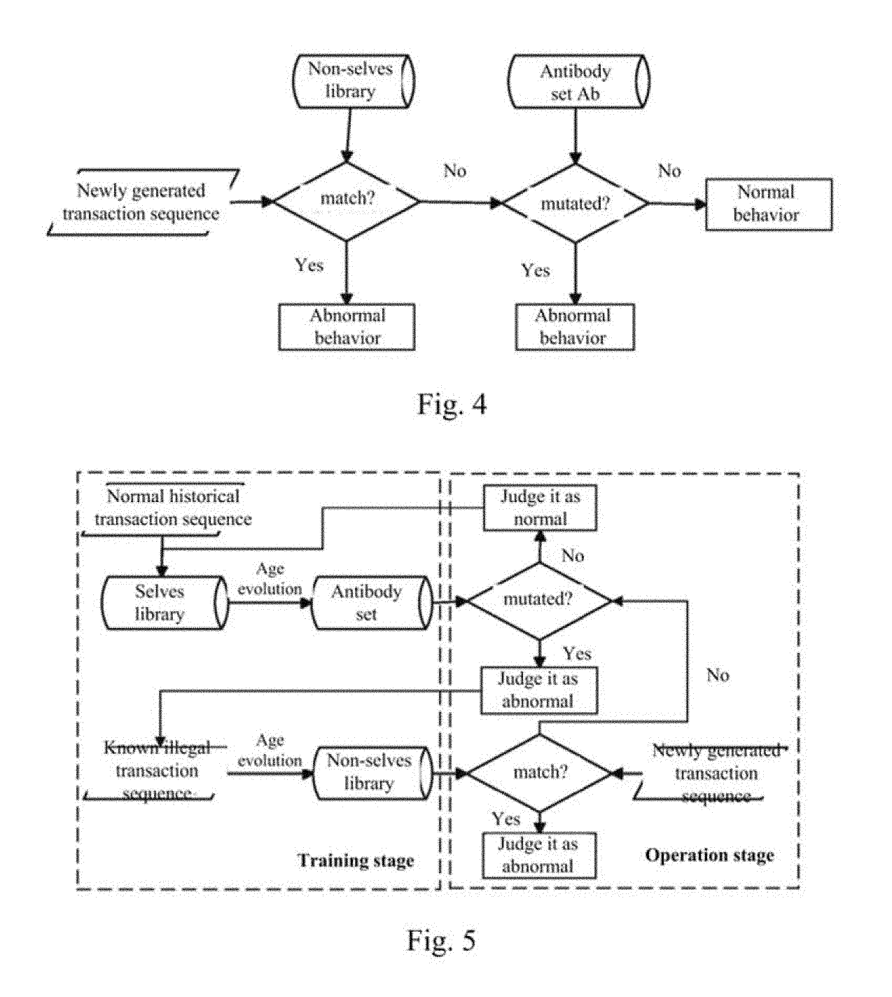

The behavior mode detection module is mainly used for performing “mutation” detection to a newly generated transaction sequence Ag in two steps, as illustrated in FIG. 4 which illustrates main functions of the module:

step one: comparing the newly generated transaction sequence Ag with the non-selves library, if matching is successful, alarming for behavior abnormality and taking relevant examination and user notification measures, or else, entering step two; and

step two: comparing the newly generated transaction sequence Ag with normal transaction sequences (i.e., the antibody set Ab), if affinity with all antibodies is very low such that possible “mutation” of the sequence is indicated, alarming for abnormality and taking corresponding measures, or else, considering a detected behavior as a normal behavior.

The updating module: FIG. 5 illustrates an overall flowchart of an immunization method, and in order to improve detection accuracy, the two mode libraries need to be updated in time. A main function of the module is updating a normal mode library and an abnormal mode library such that an immunization function to similar abnormal situations at a next time is owned on the basis that accurate detection can be performed:

according to a detection result, if the result is a normal behavior mode, performing age updating to the normal mode library (i.e., the antibody set Ab) according to the age evolution process illustrated in FIG. 3 and deleting “aged” logs therein to guarantee that the antibody set Ab can reflect recent behavior habits of the user; if the result is an abnormal behavior mode, comparing the abnormal behavior mode with modes in the abnormal library; and if the abnormal behavior mode is a new mode, adding the abnormal behavior mode into the abnormal mode library, updating the age values of non-selves sequences in the non-selves library and cleaning “aged” non-selves.

In order to know the user behavior habits, a commonly used method is a sliding window method which only considers recent logs of the user, while the immunization method considers the ages of the logs, and thus the logs may be recent transaction logs and may also be remote past logs.

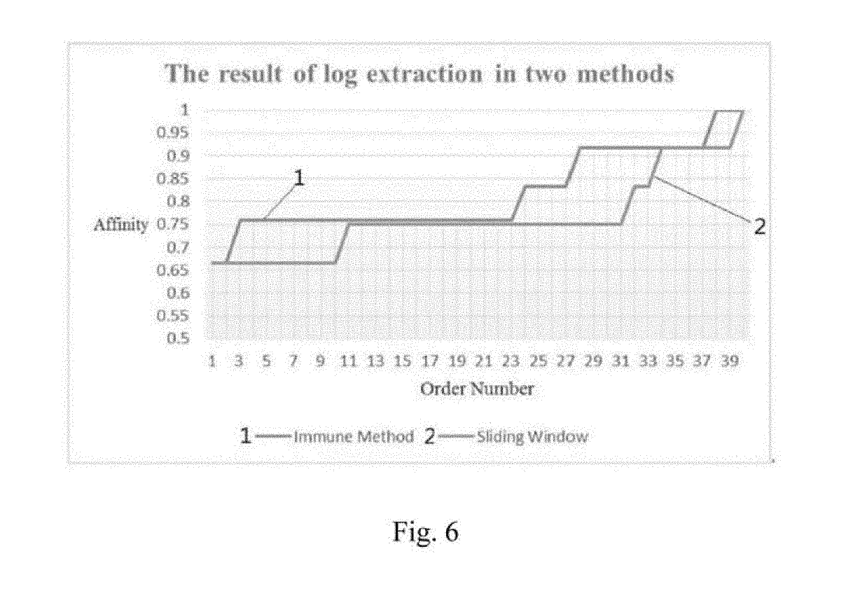

We takes one (ABDEG) of main recent sequences as a standard. Since ABDEG and ADBEG are main recent behavior sequences of the user and the affinity thereof is 0.8, 0.8 is a key parameter. In an experiment, we respectively use the sliding window method and the immunization method provided by the present invention to extract 40 behavior sequences. In order to detect the degree of reflecting the recent behavior habits of the user, affinity calculation is performed respectively to the 40 behavior sequences and the main recent behavior sequence ABDEG and FIG. 6 illustrates specific affinity distribution situations of the 40 behavior sequences extracted by adopting the two methods.

Table 1 shows results of quantitative analysis performed by adopting the two methods. It can be seen that the average affinity obtained by adopting the immunization method provided by the present invention is 0.81, which is higher than the key parameter 0.8, while the average affinity obtained by adopting the sliding window method is lower than 0.8. Accordingly, it can be seen that the logs extracted by adopting the immunization method can better reflect the recent behavior habits of the user and can be used for detecting whether the newly generated transaction sequences are in compliance with the user behavior habits or not.

TABLE 1
quantitative comparison results of two methods

| | | | | Number of |
|---|---|---|---|---|
| | | | | antibodies |
| | | Percentage of | Number of | with |
| | | antibodies with | antibodies with | affinity |
| | Average | affinity not | affinity | lower |
| | affinity | smaller than 0.8 | equal to 1 | than 0.7 |
| Sliding window | 0.76 | 20% | 1 | 10 |
| Immunization | 0.81 | 42.5% | 3 | 2 |
| method | | | | |

What is claimed is:

1. An immunization detection method for a user behavior mode in an electronic transaction process, comprising the following steps:
(1) a data preprocessing step
processing a user operation process into a sequence format and cleaning related repeated data;
(2) a training step
calculating an age value of each sequence according to a time order and according to an age evolution process, deleting aged logs according to the age values and extracting a normal sequence library (i.e., antibody), specifically:
establishing a normal sequence library (i.e., an antibody set Ab) and an abnormal sequence library (i.e., a non-selves library);
firstly performing affinity calculation to newly generated sequences and historical sequences according to an age evolution process, keeping an age unchanged if affinity is greater than a certain threshold (β, or else increasing the age value by a sequence distance therebetween;
after calculating age values of historical transaction operation sequences of a user, extracting a set of sequences with age values smaller than the threshold β according to magnitudes of ages and using the set of sequences as a normal transaction sequence library,
wherein sources of the non-selves transaction sequence library mainly comprise two aspects, one aspect is known illegal transaction sequences including some sequences with higher affinity with normal user behaviors; the other aspect is new abnormal sequences detected in the operation process; and when the newly generated abnormal transaction sequences are added into the non-selves library, the age values of non-selves in the non-selves library are updated according to the age value evolution process, active non-selves therein are reserved and self-stabilized updating of the non-selves library is realized;
(3) a behavior mode detection step
detecting whether a newly generated transaction sequence is mutated or not, wherein the detection is “mutation” detection performed aiming at the newly generated transaction sequence Ag in two steps:
step one: comparing the newly generated transaction sequence Ag with the non-selves library, if matching is successful, alarming for behavior abnormality and taking relevant examination and user notification measures, or else, entering step two;
step two: comparing the newly generated transaction sequence Ag with normal transaction sequences (i.e., the antibody set Ab), if affinity with all antibodies is very low such that possible “mutation” of the sequence is indicated, alarming for abnormality and taking corresponding measures, and contrarily, considering a detected behavior as a normal behavior; and
(4) an updating step
updating a normal mode library and an abnormal mode library:
according to a detection result, if the result is a normal behavior mode, performing age updating to the normal mode library (i.e., the antibody set Ab) according to the age evolution process and deleting “aged” logs therein to guarantee that the antibody set Ab can reflect recent behavior habits of the user; if the result is an abnormal behavior mode, comparing the abnormal behavior mode with modes in the abnormal library; and if the abnormal behavior mode is a new mode, adding the abnormal behavior mode into the abnormal mode library, updating the age values of non-selves sequences in the non-selves library and cleaning “aged” non-selves.
